(19) United States
(12) Patent Application Publication
(10) Pub. No.: US 2017/0185595 A1
(43) Pub. Date: Jun. 29, 2017

(54) SYSTEM AND METHOD FOR FILTERING INFORMATION

(71) Applicant: UDI LAVI, REHOVOT (IL)

(72) Inventor: UDI LAVI, REHOVOT (IL)

(21) Appl. No.: 14/979,633

(22) Filed: Dec. 28, 2015

(51) Int. Cl. G06F 17/30; G06K 9/18; G10L 15/26

(52) U.S. Cl. CPC G06F 17/30029; G06F 17/30026; G10L 15/26; G06K 9/18; G10L 2015/085

(57) ABSTRACT

Filtering information within a database by receiving from human reporting, multimedia information recommended to be removed, for multimedia information being analyzed regarding filtering, and for the multimedia information recommended to be removed, performing the steps of producing texts describing the multimedia information by a multimedia recognition tool, producing links, for linking the texts to the multimedia information; inserting the texts, the multimedia information and the links into the database, searching for similarity between the texts linked to the multimedia information recommended to be removed and the texts linked to the multimedia information being analyzed, and upon finding the similarity between the texts, removing multimedia information to which the texts are linked.

### TECHNICAL FIELD

The invention relates to the field of search engines. More particularly, the invention relates to a method and system for filtering speech and other multimedia information, rather than text information.

### BACKGROUND

Prior art search engines provide the results according to texts to be searched. The results may constitute texts, pictures, audio files, video files, and other multimedia information.

However, the search is based on the texts contained within the files. This dependency limits the searching capabilities, either in the case in which text is not accompanied with the multimedia information, and also in the case in which accompanied text is not directed for searching the image or the other type of the multimedia information.

### SUMMARY

In embodiments of the invention a method and system is provided for filtering information from multimedia information, especially from speech files, where text is not accompanied thereto.

Other aspects of the invention will become apparent as the description proceeds.

In one aspect, the invention is directed to a method for filtering information within a database, the method comprising the steps of:
receiving from human reporting, multimedia information recommended to be removed;
a) for multimedia information being analyzed regarding filtering, and for the multimedia information recommended to be removed, performing the steps of:
producing texts describing the multimedia information by a multimedia recognition tool;
producing links, for linking the texts to the multimedia information;
inserting the texts, the multimedia information and the links into the database;
b) searching for similarity between the texts linked to the multimedia information recommended to be removed and the texts linked to the multimedia information being analyzed; and
c) upon finding the similarity between the texts, removing multimedia information to which the texts are linked.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments, features, aspects and advantages of the invention are described herein in conjunction with the following drawings:

FIG. 1 is a diagram of a system and steps for searching multimedia information.

FIG. 2 is a diagram of the steps for searching a speech file, and the technique of producing the links described in FIG. 1.

FIG. 3 details the interactions between the third step of FIG. 1 and the search conducted by the public.

FIGS. 4 and 5 illustrate the feature of filtering multimedia contents.

FIG. 6 describes filtering steps, based on human reporting of speech information recommended to be removed.

It should be understood that the drawings are not necessarily drawn to scale.

### DETAILED DESCRIPTION

The invention will be understood from the following detailed description of embodiments, which are meant to be descriptive and not limiting. For the sake of brevity, some well-known features, methods, systems, procedures, components, circuits, and so on, are not described in detail.

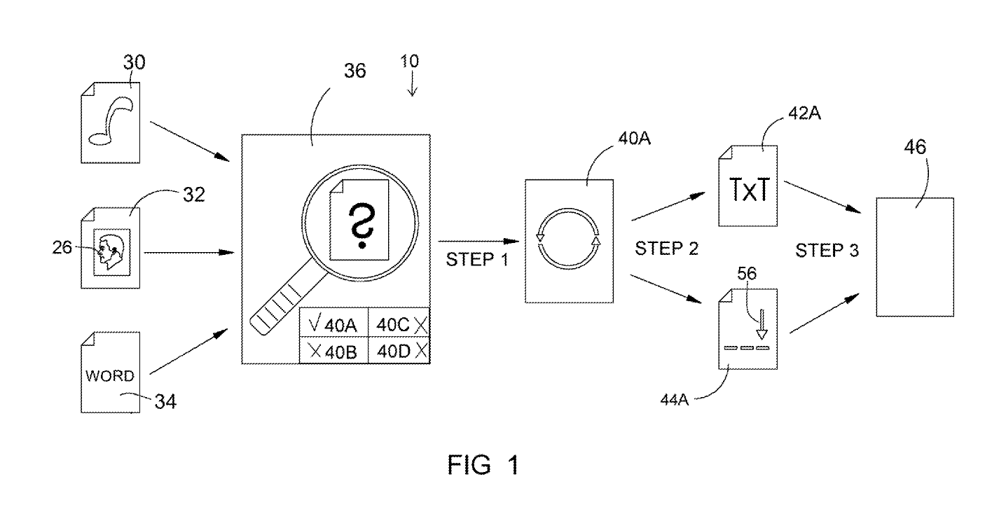

FIG. 1 is a diagram of a system and steps for searching multimedia information.

An information search system 10, according to one embodiment of the invention, allows searching within multimedia information. For example, file 30 contains audio information, such as of speech, and file 32 contains information of pictures. Information search system 10 allows searching within files 30 and 32, like a text file 34, even if they do not contain any text.

At the first step, a diagnosing tool 36 diagnoses the type of the informational files, either it is 30 or 32 or 34 is diagnosed, for selecting a decoding tool 40A from available decoding tools 40A, 40B, 40C, 40D.

The decoding tool selected by block 36 for file 30 may be an audio recognition tool, either a speech recognition tool and/or a speaker recognition tool and/or music information retrieval tool.

The decoding tool selected by block 36 for file 32 constitutes a visual pattern recognition tool, either an optical character recognition (OCR) tool for converting an image of letters to text, and/or another pattern recognition tool, which may recognize familiar patterns, e.g., of human beings, dogs, cats, maps, etc. and describe them by text.

According to the example, decoding tool 40A has been selected.

At the second step, the selected decoding tool(s) 40A analyzes the content of the file 30 or 32 or 34, and produces a text file 42A, for describing the various forms 44A of file 30 or of file 32 or of file 34.

For example, text file 42A may describe the picture of the person appearing in file 32 by the words “nose”, “eyes”, etc. According to this example, file 44A may include one subsidiary picture of the nose 26, and another subsidiary picture of the eyes, each attached to the respective text of text file 42A. Thus, file 44A is a multimedia file of file 30 or 32. However, files 42A and 44A are linked one to the other by links 56. According to the example the subsidiary picture of the nose is linked to the text “nose”.

Upon recognizing the familiar patterns, such as the nose and the eyes within the multimedia information 32, the application may further analyze relationships of the familiar patterns, for example, decide whether it is an old or young person. The text 42A may then add the word “old” or “young” to be searched by the public.

Various information providers may apply various encoding tools, for producing the texts 42A and the links to the multimedia information.

For example, computed tomography (CT) image files may be searched based on text produced therefor and linked thereto.

In contrast to the above-mentioned encoding tools which merely encode, system 10 produces texts 42A in view of the searching step, to be conducted later. The production of texts in view of the searching step may apply addition of key words, addition of titles, adapted to the searches, and analysis of the information. For example, the application preparing the text may search the date and cardinal results within the picture or the speech, and produce a title, including this date and results.

According to a simplified embodiment, system 10 allows searching within one or more types only, for example, only within the news. Then, only a single encoding tool 40A, being a speech recognition tool, is applied, for producing the text file 42A of the news file 44A.

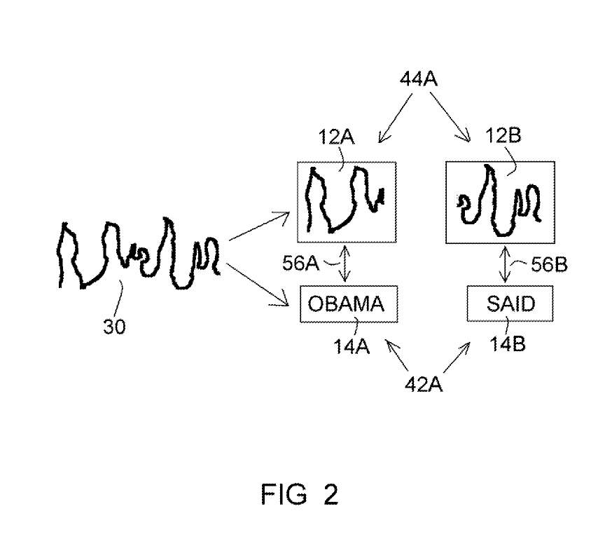

FIG. 2 is a diagram of the steps for searching a speech file, and the technique of producing the links described in FIG. 1.

Regarding the example of the news file 44A, text 42A, such as “OBAMA SAID” produced by the speech recognition tool, is divided into segments 14A, 14B, 14C, etc., for example, 14A of “OBAMA” and 14B of “SAID”. Links are 56A, 56B, 56C, etc. are provided to each segment, for linking the segment to the appropriate portion of the news file 44A. According to the example, link 56A is provided to segment 14A and link 56B is provided to segment 14B. Link 56A links to the portion 12A of multimedia news file 44A, being the signal of “OBAMA”; and link 56B links to the portion 12B of multimedia news file 44A, being the signal of “SAID”.

Referring again to FIG. 2, at the third step, text files 42A and multimedia files 44A, being linked one to the other, are stored in the main database 46, such as in a site in the World Wide Web (WWW) being ready for being searched.

Searching the main database 46 includes searching file(s) 42A and 44A, such that searching the multimedia content of file(s) 44A will be accompanied by the linked texts of file(s) 42A.

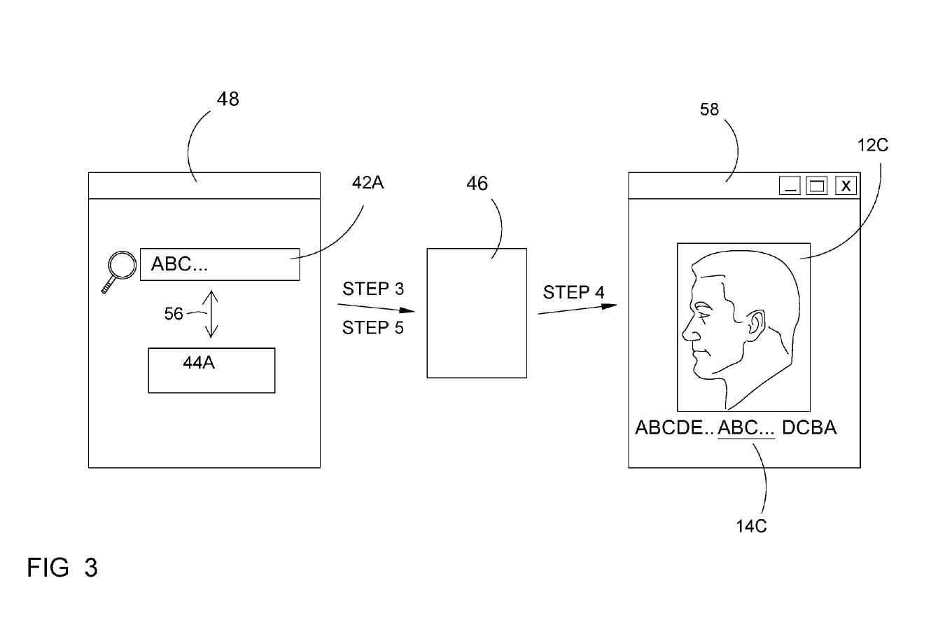

FIG. 3 details the interactions between the third step of FIG. 1 and the search conducted by the public.

Like conventional databases, the organization of the information in the main database 46 as well is dynamic, being a function of the searches conducted by the public. Unlike conventional databases, text files 42A, multimedia files 44A, and links 56 therebetween must be organized dynamically, according to the searches being conducted.

For example, at the third step, multimedia file 44A, and text file 42A, including letters “ABC” being linked to multimedia file 44A by link 56, are organized by a data organizer 48, and stored in the main database 46, being ready for being searched.

At the fourth step, a user using a search engine 58, searches the letters “ABC” within the global texts of main database 46, and finds the “ABC”, being segment 14C of text file 42A. Upon retrieving segment 14C, system 10 retrieves as well portion 12C of multimedia file 44A, which was linked to the text “ABC”, being segment 14C of text file 42A.

At the next step, the rest of text file 42A, or at least the adjacent texts thereof, and the portions of multimedia file 44A linked to these adjacent text, are as well presented to the user.

Thus, the user accesses portions of the multimedia information, even without text linked thereto, but rather through indirect text searching.

Thus, the picture of file 32 of FIG. 1 has been retrieved through the text of file 42A, which was produced externally to file 32.

At the fifth step, since the “ABC” was found to be demanded information, data organizer 48 advances this text and also portion 12C, being linked thereto.

As mentioned above, in contrast to the above-mentioned encoding tools and others, system 10 produces texts 42A in view of the searching step, to be conducted later, i.e., for being maximally searchable. Thus, the second step of producing the text file 42A may be repeated for improving the efficiency of the search made in the fourth step.

According to another application, the user may filter multimedia contents through the text attached to the multimedia contents.

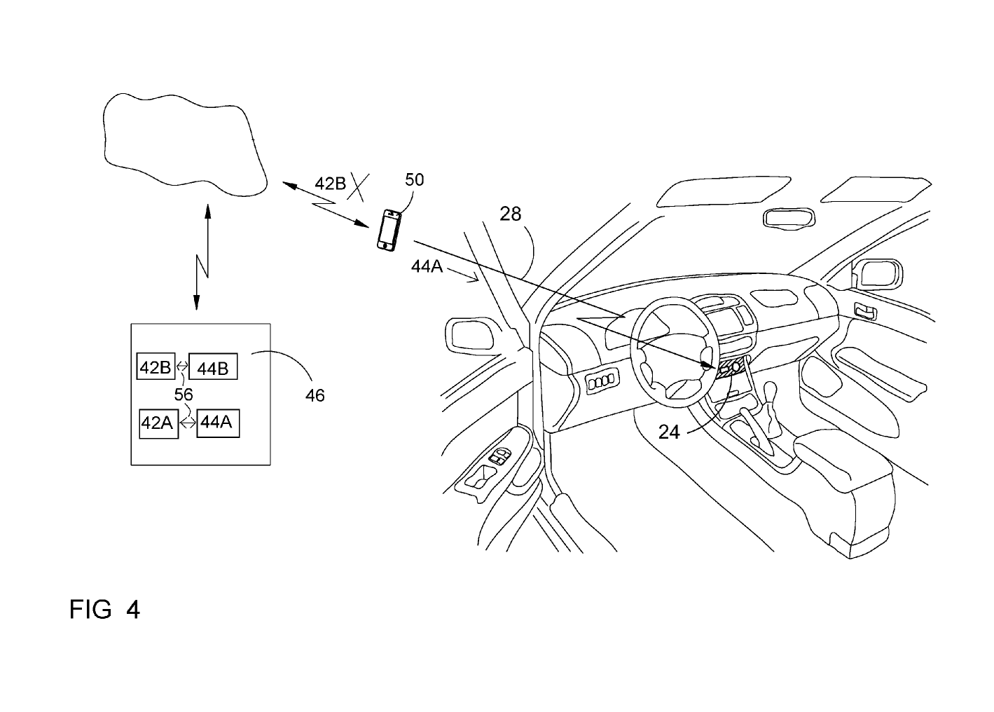

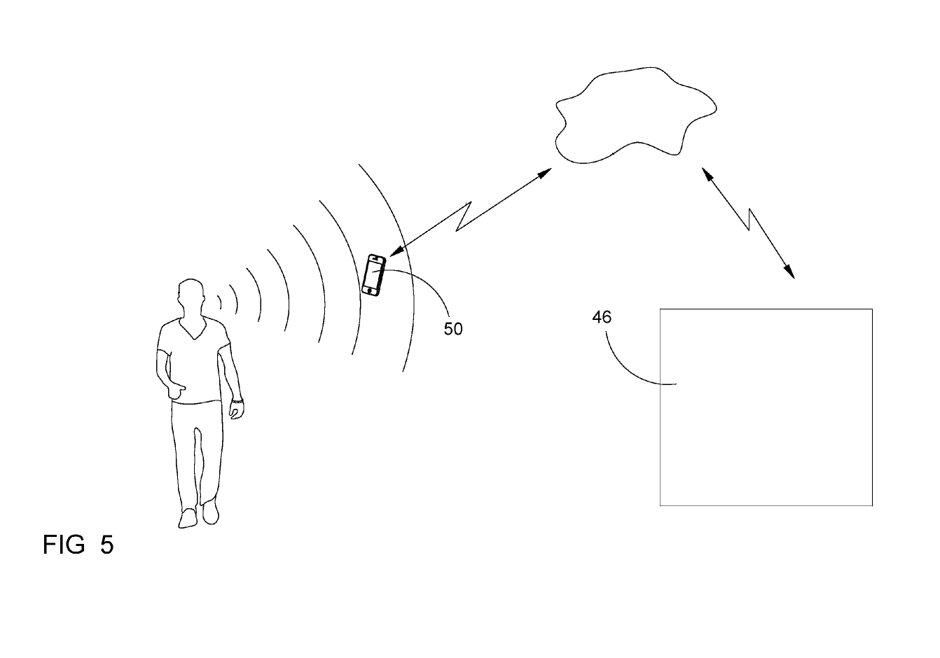

FIGS. 4 and 5 illustrate the feature of filtering multimedia contents.

Conventionally, a radio 24 plays all the contents thereof. However, a smartphone 50 may retrieve the sound through the internet from the World Wide Web, being the main database 46, and filter it.

According to the example, main database 46 contains multimedia file 44A, and text file 42A linked thereto, and also multimedia file 44B, and text file 42B linked thereto. According to the text files 42A and 42B, smartphone 50 may reject text file 42B, thus retrieving only multimedia file 44A, which will be played by radio 24 as depicted in FIG. 3 or directly, as depicted in FIG. 5.

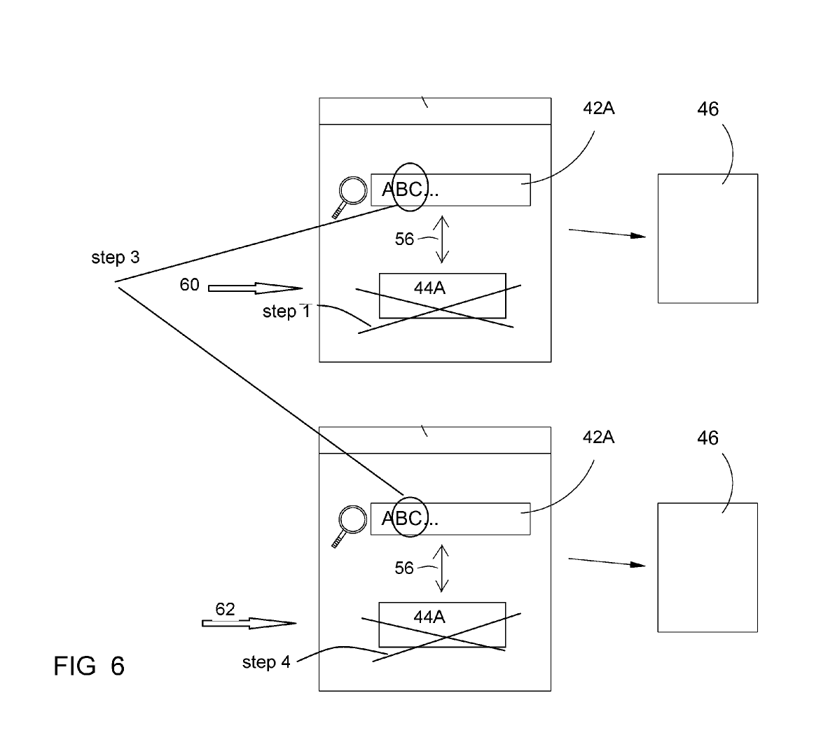

FIG. 6 describes filtering steps, based on human reporting of speech information recommended to be removed.

At the first step, people from the public, who have listened to multimedia information (44A), recommend to remove some of the information.

The following steps “learn” from these reports, removal of additional information, by applying the following steps:

At the second step,
a) for the multimedia information (44A) being analyzed (62) regarding the filtering, and for the multimedia information (44A) recommended to be removed (60), performing the steps of:
producing texts (42A) describing the multimedia information (44A) by a multimedia recognition tool (40A);
producing links (56, 56A, 56B, 56C), for linking the texts (42A) to the multimedia information (44A);
inserting the texts (42A), the multimedia information (44A) and the links (56, 56A, 56B, 56C) into the database (46);

At the third step,
b) searching, by a text comparator 64, for similarity between the texts (42A) linked to the multimedia information recommended to be removed (60) and the texts linked to the multimedia information being analyzed (62); and

At the fourth step,
c) upon finding the similarity between the texts, removing multimedia information to which the texts are linked.

Steps 1 to 4 are based on the basic method for searching information within a database (46), the method comprising the steps of:
producing (40A) texts (42A) describing speech information (44A) by a speech recognition tool (40A);
producing links (56, 56A, 56B, 56C), for linking the texts (42A) to the speech information (44A);
inserting the texts (42A), the speech information (44A) and the links (56, 56A, 56B, 56C) into the database (46); and
upon searching, and upon retrieving a text (14A) of the texts (42A) from the database (46), retrieving the speech information (44A) linked to the texts (42A), through the links (56, 56A, 56B, 56C),
thereby searching the speech information (44A) within the database (46) through the texts (42A), which are not supplied with the speech information (44A).

Another basic method for searching information within a database (46), the method comprising the steps of:
producing (40A) texts (42A) describing multimedia information (44A);
producing links (56, 56A, 56B, 56C), for linking the texts (42A) to the multimedia information (44A);
inserting the texts (42A), the multimedia information (44A) and the links (56, 56A, 56B, 56C) into the database (46); and
upon searching, and upon retrieving a text (14A) of the texts (42A) from the database (46), retrieving the multimedia information (44A) linked to the texts (42A), through the links (56, 56A, 56B, 56C), thereby searching the multimedia information (44A) within the database (46) through the texts (42A), which are not supplied with the multimedia information (44A).

Thus, in one aspect, the invention is directed to a method for filtering information within a database (46), the method comprising the steps of:
receiving from human reporting, speech information (44A) recommended to be removed (60);
a) for speech information (44A) being analyzed (62) regarding filtering, and for the speech information (44A) recommended to be removed (60), performing the steps of:
producing (40A) texts (42A) describing the speech information (44A) by a speech recognition tool (40A);
producing links (56, 56A, 56B, 56C), for linking the texts (42A) to the speech information (44A);
inserting the texts (42A), the speech information (44A) and the links (56, 56A, 56B, 56C) into the database (46);
b) searching for similarity between the texts (42A) linked to the speech information recommended to be removed and the texts linked to the speech information being analyzed; and
c) upon finding the similarity between the texts, removing speech information to which the texts are linked.

In another aspect, the invention is directed to a method for filtering information within a database (46), the method comprising the steps of:
receiving from human reporting, multimedia information (44A) recommended to be removed (60);
a) for multimedia information (44A) being analyzed (62) regarding filtering, and for the multimedia information (44A) recommended to be removed (60), performing the steps of:
producing (40A) texts (42A) describing the multimedia information (44A) by a multimedia recognition tool (40A);
producing links (56, 56A, 56B, 56C), for linking the texts (42A) to the multimedia information (44A);
inserting the texts (42A), the multimedia information (44A) and the links (56, 56A, 56B, 56C) into the database (46);
b) searching for similarity between the texts (42A) linked to the multimedia information recommended to be removed and the texts linked to the multimedia information being analyzed; and
c) upon finding the similarity between the texts, removing multimedia information to which the texts are linked.

The step of producing (40A) the texts (42A) describing the multimedia information (44A) may comprise the steps of:
diagnosing (36) a type (30, 32, 34) of the multimedia information (44A);
selecting a decoding tool (40A) from available decoding tools (40A, 40B, 40C, 40D), being suitable for the diagnosed type (30, 32, 34);
recognizing, by the selected decoding tool (40A), familiar patterns within the multimedia information (44A); and
producing texts (42A) describing the familiar patterns.

The method may further comprise the steps of:
upon the step of recognizing the familiar patterns within the multimedia information (44A), analyzing relationships of the familiar patterns,
and wherein the step of producing texts (42A) describing the familiar patterns may further comprise the step of producing texts (42A) describing the analysis of the relationships of the familiar patterns.

The step of producing (40A) the texts (42A) may comprise the step of adding textual details being substantially included in the multimedia information (44A), for improving the step of searching the texts (42A).

The step of producing (40A) the texts (42A) describing the multimedia information (44A) may comprise:
converting speech to text, and/or
converting an image of letters to text by optical character recognition (OCR), and/or
converting familiar patterns to text.

The step of producing links (56), for linking the texts (42A) to the multimedia information (44A) may comprise the steps of:
dividing the texts (42A) to segments (12A, 12B);
linking, by producing at least one link (56) for each segment, each segment to a portion (14A, 14B) of the multimedia information (44A).

The step of retrieving the text (14A) of the texts (42A) from the database (46) may comprise retrieving at least one of the segments (12A).

The method may further comprise the step of:
upon retrieving the at least one of the segments (12A) of the texts (42A), retrieving adjacent segments (12B) thereof, and retrieving portions (14B) of the multimedia information (44A) being linked to the adjacent segments (12B),
   thereby accessing portions of the multimedia information through indirect text searching.

The step of searching may comprise filtering by using the texts (42A), thereby filtering information from the multimedia information (44A) linked to the texts (42A),

thereby filtering the multimedia information (44A) within the database (46) through the texts (42A), which are not supplied with the multimedia information (44A).

In another aspect, the invention is directed to an information filtering system (10) for filtering information within a database (46), the system (10) comprising:
a decoding tool (40A), for producing (40A) texts (42A) describing multimedia information (44A);
links (56, 56A, 56B, 56C), for linking the texts (42A) to the multimedia information (44A);
storage for storing the texts (42A), the multimedia information (44A) and the links (56, 56A, 56B, 56C) within the database (46); and
a search engine (58), for searching and for retrieving the texts (42A) from the database (46), together with the multimedia information (44A), being linked to the texts (42A), through the links (56, 56A, 56B, 56C); and
a text comparator (64), for comparing between texts of different portions of multimedia information (44A),
   thereby similarity of the texts indicates similarity of the portions of multimedia information (44A).

The information filtering system (10) may further comprise:
a diagnosing tool (36), for diagnosing a type (30, 32, 34) of the multimedia information (44A), and for selecting the decoding tool (40A) from available decoding tools (40A, 40B, 40C, 40D), being suitable for the diagnosed type (30, 32, 34).

The decoding tool (40A) may comprise a tool for recognizing familiar patterns within the multimedia information (44A), and for producing texts (42A) describing the familiar patterns.

The decoding tool (40A) may comprise one or more tools selected from a group including:
a speech to text converter,
a converter for converting an image of letters to text by optical character recognition (OCR),
a converter for converting familiar patterns to text.

In the figures and/or description herein, the following reference numerals (Reference Signs List) have been mentioned:
numeral 10 denotes an information search system according to one embodiment of the invention;
numerals 12A and 12B denote portions of the multimedia file/information to be searched;
numerals 14A and 14A denote segments of the text, produced by the system;
numeral 24 denotes a radio;
numeral 26 denotes a portion of the multimedia information;
numeral 30 denotes a file containing audio information;
numeral 32 denotes a file containing visual information;
numeral 34 denotes a file containing textual information;
numeral 36 denotes a diagnosing tool, for diagnosing whether the file of audio or visual or text, or a combination thereof;
numerals 40A, 40B, 40C, 40D denote tools for decoding multimedia information, such as a speech recognition tool;
numerals 42A and 42B denote text files produced by the system;
numerals 44A and 44B denote multimedia files being linked to the text filed produced by the system;;
numeral 46 denotes a database, such as in a site in the World Wide Web (WWW);
numerals 56, 56A, 56B, 56C denote links between texts and multimedia information, either being of the entire file or of segments thereof;
numeral 48 denotes a data organizer, used by a search engine, for improving the search of the data in the database, preferably being the World Wide Web;
numeral 50 denotes a smartphone or a computer, for retrieving information from the World Wide Web;
numeral 58 denotes a search engine;
numeral 60 denotes multimedia information recommended to be removed;
numeral 62 denotes multimedia information being analyzed, whether it requires filtering for removing portions therefrom; and
numeral 64 denotes a text comparator.

In the description herein, the following references have been mentioned:

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A method for filtering information within a database, the method comprising the steps of:
receiving from human reporting, speech information recommended to be removed;
a) for speech information being analyzed regarding filtering, and for said speech information recommended to be removed, performing the steps of:
producing texts describing said speech information by a speech recognition tool;
producing links, for linking said texts to said speech information;
inserting said texts, said speech information and said links into said database;
b) searching for similarity between said texts linked to said speech information recommended to be removed and said texts linked to said speech information being analyzed; and
c) upon finding said similarity between said texts, removing speech information to which said texts are linked.

2. A method for filtering information within a database, the method comprising the steps of:
receiving from human reporting, multimedia information recommended to be removed;
a) for multimedia information being analyzed regarding filtering, and for said multimedia information recommended to be removed, performing the steps of:
producing texts describing said multimedia information by a multimedia recognition tool;
producing links, for linking said texts to said multimedia information;
inserting said texts, said multimedia information and said links into said database;
b) searching for similarity between said texts linked to said multimedia information recommended to be removed and said texts linked to said multimedia information being analyzed; and
c) upon finding said similarity between said texts, removing multimedia information to which said texts are linked.

3. A method according to claim 2, wherein said step of producing said texts describing said multimedia information comprises the steps of:
diagnosing a type of said multimedia information;
selecting a decoding tool from available decoding tools, being suitable for the diagnosed type;
recognizing, by the selected decoding tool, familiar patterns within said multimedia information; and
producing texts describing said familiar patterns.

4. A method according to claim 3, further comprising the steps of:
upon said step of recognizing the familiar patterns within said multimedia information, analyzing relationships of said familiar patterns,
and wherein said step of producing texts describing said familiar patterns further comprises the step of producing texts describing the analysis of the relationships of said familiar patterns.

5. A method according to claim 2, wherein said step of producing said texts comprises the step of adding textual details being substantially included in said multimedia information, for improving said step of searching said texts.

6. A method according to claim 2, wherein said step of producing said texts describing said multimedia information comprises one or more steps selected from a group including:
converting speech to text,
converting an image of letters to text by optical character recognition (OCR),
converting familiar patterns to text.

7. A method according to claim 2, wherein said step of producing links, for linking said texts to said multimedia information comprises the steps of:
dividing said texts to segments;
linking, by producing at least one link for each segment, each segment to a portion of said multimedia information.

8. A method according to claim 7, wherein said step of retrieving said text of said texts from said database comprises retrieving at least one of said segments.

9. A method according to claim 8, further comprising the step of:
upon retrieving said at least one of said segments of said texts, retrieving adjacent segments thereof, and retrieving portions of said multimedia information being linked to said adjacent segments,
thereby accessing portions of said multimedia information through indirect text searching.

10. A method according to claim 2, wherein said step of searching comprises filtering by using said texts,
thereby filtering information from said multimedia information linked to said texts,
thereby filtering said multimedia information within said database through said texts, which are not supplied with said multimedia information.

11. An information filtering system for filtering information within a database, the system comprising:
a decoding tool, for producing texts describing multimedia information;
links, for linking said texts to said multimedia information;
storage for storing said texts, said multimedia information and said links within said database;
a search engine, for searching and retrieving said texts from said database, together with said multimedia information, being linked to said texts, through said links; and
a text comparator, for comparing between texts of different portions of multimedia information,
thereby similarity of said texts indicates similarity of said portions of multimedia information.

12. An information filtering system according to claim 11, further comprising:
a diagnosing tool, for diagnosing a type of said multimedia information, and for selecting said decoding tool from available decoding tools, being suitable for the diagnosed type.

13. An information filtering system according to claim 10, wherein said decoding tool comprises a tool for recognizing familiar patterns within said multimedia information, and for producing texts describing said familiar patterns.

14. An information filtering system according to claim 11, wherein said decoding tool comprises one or more tools selected from a group including:
a speech to text converter,
a converter for converting an image of letters to text by optical character recognition (OCR),
a converter for converting familiar patterns to text.
